(19) United States
(12) Patent Application Publication
(10) Pub. No.: US 2025/0292973 A1
(43) Pub. Date: Sep. 18, 2025

(54) TRIGGER SWITCH

(71) Applicant: OMRON Corporation, KYOTO (JP)

(72) Inventors: Tetsuya KOIDE, Kyoto-shi (JP); Kazushi MAETA, Kyoto-shi (JP); Hiroaki FUJINO, Kyoto-shi (JP)

(73) Assignee: OMRON Corporation, KYOTO (JP)

(21) Appl. No.: 19/047,632

(22) Filed: Feb. 7, 2025

(30) Foreign Application Priority Data
Mar. 13, 2024 (JP) 2024-038590

(51) Int. Cl. H01H 13/06; B25F 5/00

(52) U.S. Cl. CPC H01H 13/06; B25F 5/00; H01H 2013/066

(57) ABSTRACT

A trigger switch TS includes: a shaft member 2, receiving a press-in operation and moving from a first side toward a second side; and a housing 3, movably accommodating the second side. The trigger switch includes: a flexible external tubular member 5, covering the shaft member; and a flexible internal tubular member 7, accommodated inside the housing and attached to the other side of the shaft member 2. In the housing, a through hole 31 is formed on a front wall part 30, and a ventilation hole 33a is formed on a rear wall part 33. In the external tubular member, an end is sealed on the first side, and an opening on the second side is tightly adhered to the through hole. In the internal tubular member, an opening on the first side is sealed, and an opening on the second side is tightly adhered to the ventilation hole.

### CROSS-REFERENCE TO RELATED APPLICATION

This application claims the priority benefit of Japan application serial no. 2024-038590, filed on Mar. 13, 2024. The entirety of the above-mentioned patent application is hereby incorporated by reference herein and made a part of this specification.

### BACKGROUND

### Technical Field

The invention relates to a trigger switch including a shaft member and a housing. A trigger cap that receives a press-in operation is attached to the shaft member, and the shaft member is inserted through the housing.

### Description of Related Art

For the operation for an electric tool, a trigger switch is used. The trigger switch includes: a trigger cap that receives a press-in operation by an operator; a shaft member (plunger) in which the trigger cap is attached to an end side; and a housing that accommodates the other end side of the shaft member. Since a contact component, etc., for turning on and off a circuit is accommodated in the housing, airtightness is required in the housing for the purpose of waterproofness and dustproofness.

In the case where the operator performs a press-in operation on the trigger switch, in accordance with the stroke relating to the press-in operation, the shaft member is pressed into the housing or pressed out of the housing. By moving the shaft member with respect to the housing, the air pressure inside the housing changes. Since the changes of air pressure in the housing exert an adverse effect on airtightness such as waterproofness and dustproofness, various solutions have been proposed (see, for example, Patent Document 1).

### PRIOR ART DOCUMENT(S)

### Patent Document(s)

[Patent Document 1] Japanese Patent Application Laid-open No. 2013-054310

As described above, airtightness of the housing is required for a trigger switch.

The invention provides a trigger switch capable of enhancing airtightness.

### SUMMARY

A trigger switch of the invention includes: a shaft member, in which a trigger cap receiving a press-in operation and moving from a first side toward a second side is attached to the first side; and a housing, movably accommodating the second side of the shaft member. The trigger switch includes: an external tubular member, being flexible and covering the shaft member outside the housing; and an internal tubular member, being flexible, accommodated inside the housing and attached to the second side of the shaft member. In the housing, a through hole through which the shaft member is inserted is formed on a first wall part on the first side, and a ventilation hole is formed on a second wall part on the second side. In the external tubular member, an end on the first side is sealed on the first side of the shaft member, and an opening on the second side is tightly adhered to a periphery of the through hole. In the internal tubular member, an end on the first side is sealed, and an opening on the second side is tightly adhered to a periphery of the ventilation hole.

### BRIEF DESCRIPTION OF THE DRAWINGS

FIG. 1 is a schematic perspective view illustrating an example of the appearance of an electric device according to the invention.

FIG. 2 is a schematic perspective view illustrating an example of the appearance of a trigger switch according to the invention.

FIG. 3 is a schematic perspective view illustrating an example of the appearance of the trigger switch according to the invention.

FIG. 4 is an exploded perspective view illustrating an example of the internal structure of the trigger switch according to the invention.

FIG. 5 is an exploded perspective view illustrating an example of the internal structure of the trigger switch according to the invention.

FIG. 6 is a side cross-sectional view illustrating an example of the internal structure of the trigger switch according to the invention.

FIG. 7 is a side cross-sectional view illustrating an example of the internal structure of the trigger switch according to the invention.

FIG. 8 is a side cross-sectional view illustrating an example of the internal structure of the trigger switch according to the invention.

### DESCRIPTION OF THE EMBODIMENTS

A trigger switch of the invention includes: a shaft member, in which a trigger cap receiving a press-in operation and moving from a first side toward a second side is attached to the first side; and a housing, movably accommodating the second side of the shaft member. The trigger switch includes: an external tubular member, being flexible and covering the shaft member outside the housing; and an internal tubular member, being flexible, accommodated inside the housing and attached to the second side of the shaft member. In the housing, a through hole through which the shaft member is inserted is formed on a first wall part on the first side, and a ventilation hole is formed on a second wall part on the second side. In the external tubular member, an end on the first side is sealed on the first side of the shaft member, and an opening on the second side is tightly adhered to a periphery of the through hole. In the internal tubular member, an end on the first side is sealed, and an opening on the second side is tightly adhered to a periphery of the ventilation hole.

In addition, in the trigger switch, a total of a volume of a space inside the external tubular member and a volume of a space excluding a space occupied by internal tubular member from the housing remains substantially constant regardless of a position of the shaft member.

In addition, in the trigger switch, an inside of the external tubular member and an inside of the housing are in communication via the through hole, so that a gas is able to pass through.

In addition, the trigger switch includes: a movable contact, accommodated in the housing and attached to the second side of the shaft member; and a fixed contact, attached to the inside of the housing and making and breaking contact with the movable contact. The movable contact and the fixed contact are disposed in a region where the gas is able to pass.

In addition, in the trigger switch, a biasing member, biasing the shaft member toward the first side, and the external tubular member or the internal tubular member covers the biasing member.

In addition, in the trigger switch, the first side of the external tubular member is open, and the first side of the external tubular member is fixed in a state of being tightly adhered to a periphery in a vicinity of the end on the first side of the shaft member.

The trigger switch of the invention exhibits excellent effects, such as being able to enhance the airtightness of the housing.

The following describes an embodiment of the invention with reference to the drawings.

### Application Example

The trigger switch of the invention is applicable to various electric devices including electric tools such as electric drills, electric screwdrivers, electric wrenches, electric grinders, etc., which include a drive unit such as a motor. The following describes an electric device PT and a trigger switch TS attached to the electric device PT as illustrated in the drawings with reference to the drawings.

### <Electric Device PT>

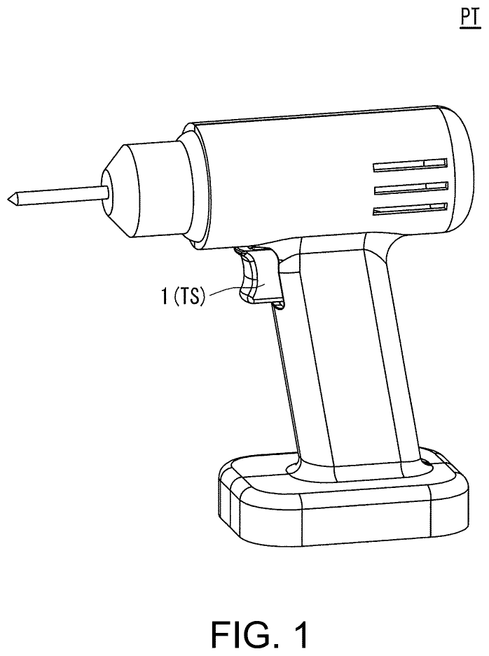

FIG. 1 is a schematic perspective view illustrating an example of the appearance of the electric device PT according to the invention. The electric device PT of the invention can be applied to electric tools including electric drills, electric screwdrivers, electric wrenches, electric grinders, and can further be applied to various devices such as water guns, paint guns, model guns, etc., that include the trigger switch TS. The electric device PT exemplified in FIG. 1 has a shape in which a handheld portion is attached to a substantially cylindrical shape body portion that accommodates a drive unit (not shown) such as an electric motor. The trigger switch TS used for operating the electric device PT is attached to the handheld portion. In the following description, as shown in the drawings, the direction of the substantially cylindrical shape body portion is described as up, and the direction of the handheld portion is described as lower. Also, the direction in which the rotating tool portion such as a drill is attached is described as front, and the direction in which the trigger switch TS is pressed in is described as rear. In other words, in the trigger switch TS incorporated in the electric device PT, the direction from the front toward the rear becomes the press-in direction in the press-in operation. Such expressions are directions for the ease of description and do not limit the direction of use of the electric device PT and the trigger switch TS.

### <Trigger Switch TS>

Next, the trigger switch TS included in the electric device PT will be described. In the electric device PT exemplified in FIG. 1, the trigger cap 1 of the trigger switch TS, which receives the press-in operation from the operator, is exposed to the outside of the electric device PT. The trigger switch TS is a device that receives the press-in operation from the operator, and is incorporated into the electric device PT in the state in which the trigger cap 1 exposed, so as to be operable. The trigger cap 1 of the trigger switch TS moves from a release position where the trigger switch does not receive the press-in operation as shown in FIG. 1, in the press-in direction (from the [first side] that is the front toward the [second side] that is the rear) by receiving the press-in operation.

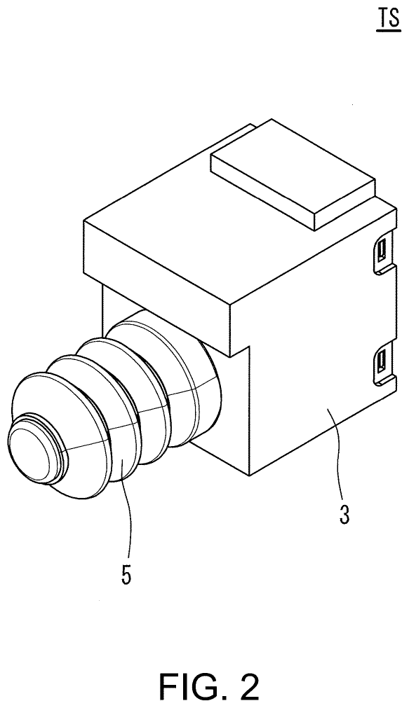

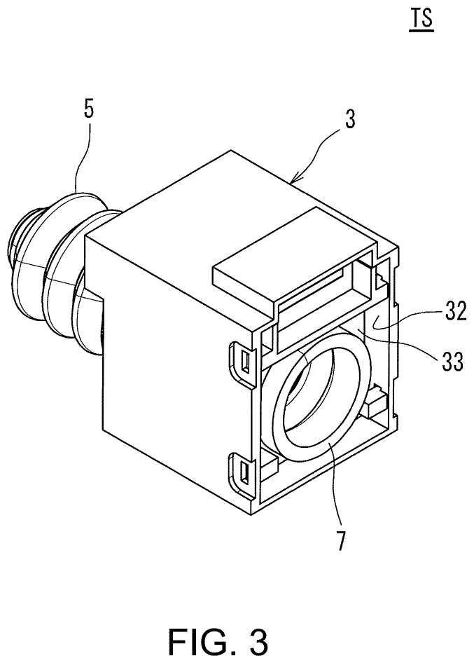

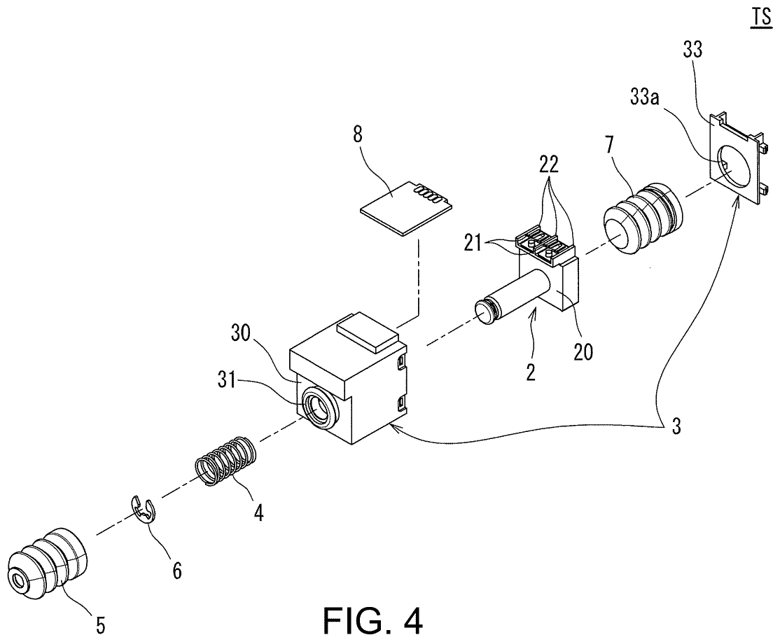

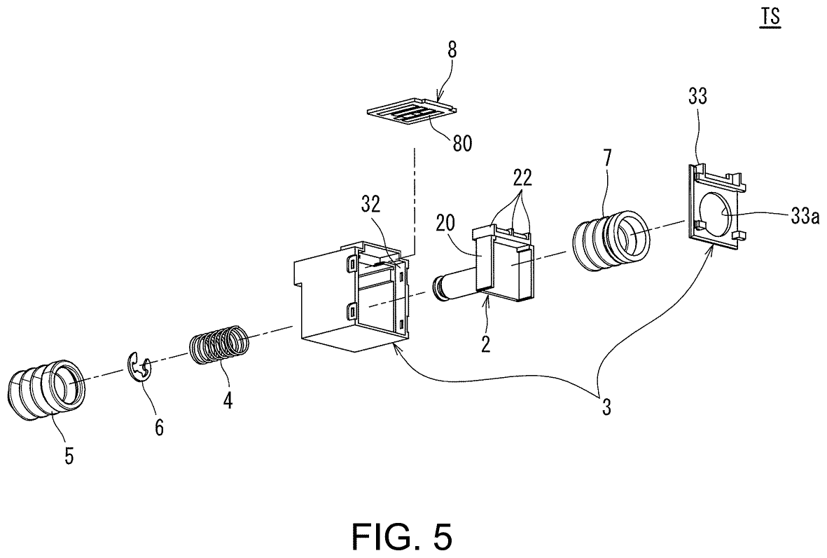

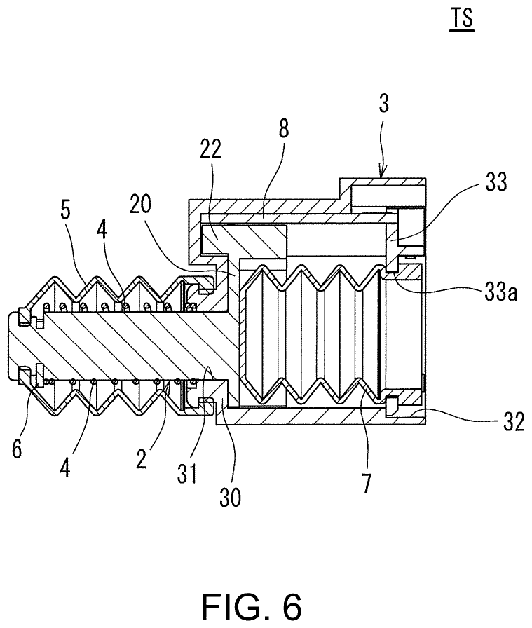

The internal structure of the trigger switch TS will be described. FIG. 2 and FIG. 3 are schematic perspective views illustrating an example of the appearance of the trigger switch TS of the invention. FIG. 4 and FIG. 5 are exploded perspective views illustrating an example of the internal structure of the trigger switch TS of the invention. FIG. 6 is a side cross-sectional view illustrating an example of the internal structure of the trigger switch TS according to the invention. FIG. 2 to FIG. 6 exemplify the state where the trigger cap 1 is removed from the trigger switch TS to make the structure easier to visually recognize. The trigger cap 1 can be attached to/removed from the trigger switch TS.

The trigger switch TS includes, in addition to the trigger cap 1 shown in FIG. 1, various components such as a shaft member 2, a housing 3, a biasing member 4, an external tubular member 5, a fastener 6, an internal tubular member 7, a substrate 8, etc.

The shaft member 2 is a plunger that transmits the operation received by the trigger cap 1. The shaft member 2 has the trigger cap 1 attached to the front side (first side), and the rear side (second side) of the shaft member 2 is accommodated in the substantially parallelepiped housing 3. The rear side of the shaft member 2 is accommodated in a state of being able to be movably inserted into a through hole 31 provided on a front wall part 30 (first wall part) on the front surface of the housing 3. The outer diameter of the movable shaft member 2 is formed slightly smaller than the inner diameter of the through hole 31 A movable wall 20 is formed at the rear end of the shaft member 2 located inside the housing 3. The movable wall 20 is an inner wall with the front-rear direction as the thickness direction, and is formed in a hollow parallelepiped shape with the rear surface and the bottom surface being open. On the upper surface of the movable wall 20, a pair of movable contacts 21 are arranged and attached in the left-right direction, and partition walls 22 are formed between the pair of movable contacts 21 and on the outer sides of the movable contacts 21. A substantially parallelepiped space is formed inside the housing 3, and the external shape of the movable wall 20 including the partition walls 22 in the upper-lower and left-right directions is formed slightly smaller than the inner diameter of the housing 3 in the upper-lower and left-right directions. Therefore, together with the front-rear movement of the shaft member 2, the movable wall 20 formed at the rear end of the shaft member 2 moves back and forth in the housing 3. On the upper surface of the movable wall 20, the regions divided by the partition walls 22 become the regions where the movable contacts 21 and fixed contacts 80 make and break contact, and the regions form gaps with the inner ceiling of the housing 3 by using the partition walls 22. Consequently, at the regions where the movable contacts 21 and the fixed contacts 80 are disposed, as well as the gaps between the movable wall 20 and the inner surface of the housing 3, a gas is able to pass.

On the front side of the shaft member 2 exposed to the outside of the housing 3, a biasing member 4, such as a compression coil spring, is wound, and the biasing member 4 biases the shaft member 2 forward (toward the first side). The front end side of the biasing member 4 is fixed to the shaft member 2 by using the fastener 6, such as an e-ring, and the rear end is fixed in a state of abutting against the front wall part 30 of the front surface of the housing 3. Furthermore, the front part of the shaft member 2 exposed to the outside of the housing 3 and the biasing member 4 winding around the front part of the shaft member 2 are covered by the external tubular member formed in a substantially tubular shape by using a flexible material such as resin. The external tubular member 5 forms a bellows shape that extends and contracts in the longitudinal direction, and the opening at the front end (first side) is fixed in a tightly adhered state by tightening the periphery in the vicinity of the front end of the shaft member 2. In other words, the front end of the external tubular member 5 is sealed at the front part of the shaft member 2. The rear end (second side) of the external tubular member 5 is fixed in a tightly adhered state to the periphery of the through hole 31 on the front surface of the housing 3. Therefore, the external tubular member 5 seals from the through hole 31 on the front surface of the housing 3 to the vicinity of the front end of the shaft member 2. Also, as described, the outer diameter of the shaft member 2 is formed slightly smaller than the inner diameter of the through hole 31. Consequently, the inside of the tube of the external tubular member 5 and the inside of the housing 3 are in communication so that gas can enter and exit through the through hole 31. The state where the rear end of the external tubular member 5 tightly adheres to the periphery of the through hole 31 indicates that the inside of the external tubular member 5 and the inside of the housing 3 are sealed in a state of being in communication, through the opening of the rear end of the external tubular member 5 and the through hole 31. Therefore, the trigger switch TS of the invention can be realized in various forms, such as internally fitting the external tubular member 5 with the through hole 31, in addition to externally fitting the opening of the external tubular member 5 with the protrusion on the periphery of the through hole 31 as described above.

The housing 3 is formed in a substantially rectangular parallelepiped hollow shape, and various components such as the rear side of the shaft member 2, the internal tubular member 7, and the substrate 8 are accommodated therein. On the front wall part 30 on the front surface of the housing 3, the through hole 31 in a substantially circular shape is formed. The shaft member 2 is inserted through the through hole 31. The rear surface of the housing 3 is an opening 32, and the opening 32 is closed by a rear wall part (second wall part) 33. The rear wall part 33 is formed in a substantially rectangular plate shape matching the shape of the opening part 32, and can close the opening 32 by being fitting with the opening part 32. A substantially circular ventilation hole 33a is formed substantially at the center of the rear wall part 33.

The internal tubular member 7 accommodated in the housing 3 is a component formed in a substantially tubular shape by using a flexible material such as resin. The internal tubular member 7 forms a bellows shape that extends and contracts in the longitudinal direction, and the front end (first side) is sealed, and is fixed in a state of abutting against the rear surface of the movable wall 20 of the shaft member 2. The rear end (second side) of the internal tubular member 7 is fixed in a state of tightly adhering to the periphery of the ventilation hole 33a of the rear wall part 33 of the housing 3. Therefore, in the internal tubular member 7, the front end side is sealed, and the rear end side is open to the outside of the housing 3. As a result, while a gas outside the housing 3 enters and exits the inside of the tube of the internal tubular member 7, the air inside the housing 3 cannot enter or exit. The state where the rear end of the internal tubular member 7 is tightly adhered to the periphery of the ventilation hole 33a means that the inside of the internal tubular member 7 and the outside of the housing 3 are in a state of being in communication, through the opening at the rear end of the internal tubular member 7 and the ventilation hole 33a, while being sealed so that gas cannot enter or exit from the inside of the housing 3. Therefore, the trigger switch TS of the invention can be realized in various forms, such as fixing the internal tubular member 7 to the periphery of the ventilation hole 33a, in addition to internally fitting and fixing the rear end of the internal tubular member 7 to the ventilation hole 33a as exemplified.

The substrate 8 is plate-shaped and attached to the inner ceiling of the housing 3. A pair of the fixed contacts 80 are attached to the lower surface of the substrate 8. The fixed contacts 80 form a circuit with the movable contacts 21 attached to the movable wall 20 of the shaft member 2. Together with the movement of the shaft member 2 in the front-rear direction, the movable contact 21 moves. Through the movement, the movable contacts 21 make and break contact with the fixed contacts 80 and turn on and off the circuit.

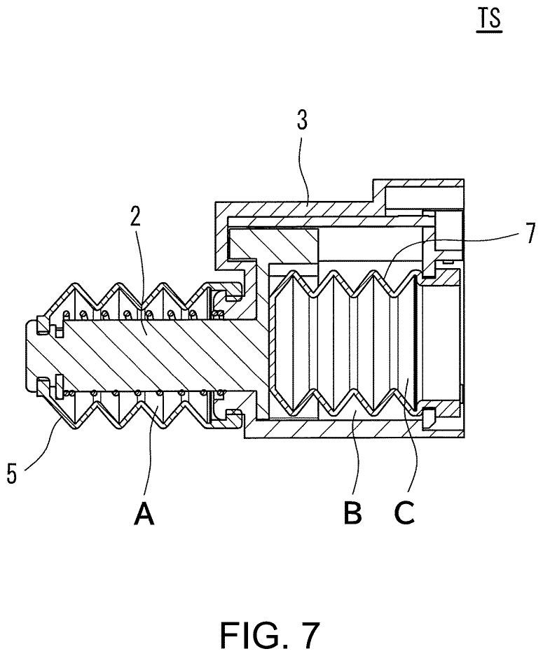

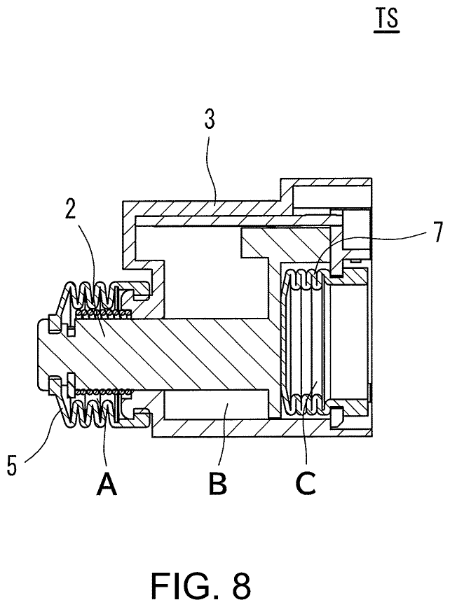

Next, the operation of the trigger switch TS will be described. FIGS. 7 and 8 are side cross-sectional views illustrating an example of the internal structure of the trigger switch TS according to the invention. FIG. 7 shows the trigger switch TS in a released state without receiving a press-in operation, and FIG. 8 shows the trigger switch TS in a state after receiving the press-in operation. Through receiving the press-in operation from the operator, the trigger switch TS transitions from the released state shown in FIG. 7 to the pressed-in state shown in FIG. 8. Additionally, with the operator releasing the press-in operation, the trigger switch TS transitions from the pressed-in state shown in FIG. 8 to the released state shown in FIG. 7 by biasing the shaft member 2 by the biasing member 4.

Through the transitioning from the released state to the pressed-in state, the shaft member 2 moves in the press-in direction. Through the movement of the shaft member 2, the external tubular member 5 and the internal tubular member 7 are shortened in the axial direction, and the tubular inner volumes of the respective tubes decreases. As the tubular inner volume of the external tubular member 5 decreases, the gas inside the tube flows out into the housing 3, and the tubular inner pressure is maintained to be substantially constant. As the tubular inner volume of the internal tubular member 7 decreases, the gas inside the tube flows to the outside, and the space occupied by the internal tubular member 7 in the housing 3 decreases. Although the gas flows into the housing 3 from the external tubular member 5, the pressure inside the housing 3 is maintained to be substantially constant because the space occupied by the internal tubular member 7 decreases. Inside the housing 3, the movable wall 20 at the rear end moves in the press-in direction together with the movement of the shaft member 2. However, a gas is able to pass through because gaps are provided in the regions where the movable contacts 21 and the fixed contacts 80 are disposed between the movable wall 20 and the inner surface of the housing 3. Therefore, inside the housing 3, the pressures at the front and the rear of the movable wall 20 are substantially equal.

As described above, in the trigger switch TS of the invention, the total of the volume of the space (A in the figure) inside the external tubular member 5 and the volume of the space (B in the figure) excluding the space occupied by the internal tubular member 7 from the housing 3 remains substantially constant regardless of the position of the shaft member 2. In other words, the pressure inside the housing 3 is substantially constant. Additionally, in the trigger switch TS of the invention, the volume of the space inside the external tubular member 5 and the volume of the space (C in the figure) inside the internal tubular member 7 are approximately equal regardless of the position of the shaft member 2.

As described above, in the trigger switch TS of the invention, even if the trigger moves through receiving a press-in operation, the pressure can be ensured to be substantially constant in the space inside the housing 3 (a space excluding the space occupied by the internal tubular member 7 inside the housing 3) where the movable contacts 21 and the fixed contacts 80 are disposed. Accordingly, the trigger switch TS of the invention can suppress the occurrence of a breathing action where the pressure changes inside the housing 3, particularly in the space including the regions where the movable contacts 21 and the fixed contacts 80 are disposed. Therefore, the trigger switch TS of the invention exhibits excellent effects, such as being able to maintain airtightness including waterproofness and dustproofness.

The invention is not limited to the embodiments described above and can be implemented in various other forms. Therefore, thee embodiments are merely examples in all respects and should not be interpreted as limiting. The scope of the invention is indicated by the claims, and is not bound by the specification text in any way. Furthermore, modifications and changes within the equivalent scope of the claims are all within the scope of the invention.

For example, the trigger switch according to the embodiment shows a configuration in which the opening on the first side of the external tubular member is sealed by tightly adhering the vicinity of the end on the first side of the shaft member, but the invention is not limited to this. It can be developed into various configurations, such as sealing the opening on the first side by using the trigger cap.

Additionally, for example, the trigger switch according to the embodiment shows a configuration in which a gas enters and exits through the through hole through which the shaft member is inserted, but the invention is not limited to this. It can be developed into various configurations, such as providing a hole for air to enter and exit in addition to the through hole.

Furthermore, for example, the trigger switch according to the embodiment shows a configuration in which the biasing member is disposed outside the housing and covered by the external tubular member, but the invention is not limited to this. It can be developed into various configurations, such as disposing the biasing member inside the housing and covering it with the internal tubular member.

In other words, the trigger switch of the invention can be developed into various configurations related to the following appendices, including the above embodiments.

### (Appendix 1)

A trigger switch, includes: a shaft member, in which a trigger cap receiving a press-in operation and moving from a first side toward a second side is attached to the first side; and a housing, movably accommodating the second side of the shaft member. The trigger switch includes: an external tubular member, being flexible and covering the shaft member outside the housing; and an internal tubular member, being flexible, accommodated inside the housing and attached to the second side of the shaft member. In the housing, a through hole through which the shaft member is inserted is formed on a first wall part on the first side, and a ventilation hole is formed on a second wall part on the second side. In the external tubular member, an end on the first side is sealed on the first side of the shaft member, and an opening on the second side is tightly adhered to a periphery of the through hole. In the internal tubular member, an end on the first side is sealed, and an opening on the second side is tightly adhered to a periphery of the ventilation hole.

### (Appendix 2)

In the trigger switch according to Appendix 1, a total of a volume of a space inside the external tubular member and a volume of a space excluding a space occupied by internal tubular member from the housing remains substantially constant regardless of a position of the shaft member.

### (Appendix 3)

In the trigger switch according to Appendix 1 or Appendix 2, an inside of the external tubular member and an inside of the housing are in communication via the through hole, so that a gas is able to pass through.

### (Appendix 4)

In the trigger switch according to Appendix 3, a movable contact, accommodated in the housing and attached to the second side of the shaft member; and a fixed contact, attached to the inside of the housing and making and breaking contact with the movable contact. The movable contact and the fixed contact are disposed in a region where the gas is able to pass.

(Appendix 5)

In the trigger switch according to any one of Appendix 1 to Appendix 4, a biasing member, biasing the shaft member toward the first side, and the external tubular member or the internal tubular member covers the biasing member.

### (Appendix 6)

In the trigger switch according to any one of Appendix 1 to Appendix 5, the first side of the external tubular member is open, and the first side of the external tubular member is fixed in a state of being tightly adhered to a periphery in a vicinity of the end on the first side of the shaft member.

What is claimed is:

1. A trigger switch, comprising: a shaft member, in which a trigger cap receiving a press-in operation and moving from a first side toward a second side is attached to the first side; and a housing, movably accommodating the second side of the shaft member, the trigger switch comprising:
an external tubular member, being flexible and covering the shaft member outside the housing; and
an internal tubular member, being flexible, accommodated inside the housing and attached to the second side of the shaft member,
wherein, in the housing,
a through hole through which the shaft member is inserted is formed on a first wall part on the first side, and
a ventilation hole is formed on a second wall part on the second side,
in the external tubular member,
an end on the first side is sealed on the first side of the shaft member, and
an opening on the second side is tightly adhered to a periphery of the through hole, and
in the internal tubular member,
an end on the first side is sealed, and
an opening on the second side is tightly adhered to a periphery of the ventilation hole.

2. The trigger switch as claimed in claim 1, wherein a total of a volume of a space inside the external tubular member and a volume of a space excluding a space occupied by internal tubular member from the housing remains substantially constant regardless of a position of the shaft member.

3. The trigger switch as claimed in claim 1, wherein an inside of the external tubular member and an inside of the housing are in communication via the through hole, so that a gas is able to pass through.

4. The trigger switch as claimed in claim 3, comprising:
a movable contact, accommodated in the housing and attached to the second side of the shaft member; and
a fixed contact, attached to the inside of the housing and making and breaking contact with the movable contact,
wherein the movable contact and the fixed contact are disposed in a region where the gas is able to pass.

5. The trigger switch as claimed in claim 1, comprising:
a biasing member, biasing the shaft member toward the first side, and
the external tubular member or the internal tubular member covers the biasing member.

6. The trigger switch as claimed in claim 1, wherein the first side of the external tubular member is open, and the first side of the external tubular member is fixed in a state of being tightly adhered to a periphery in a vicinity of the end on the first side of the shaft member.

7. The trigger switch as claimed in claim 2, wherein an inside of the external tubular member and an inside of the housing are in communication via the through hole, so that a gas is able to pass through.

8. The trigger switch as claimed in claim 2, comprising:
a biasing member, biasing the shaft member toward the first side, and
the external tubular member or the internal tubular member covers the biasing member.

9. The trigger switch as claimed in claim 2, wherein the first side of the external tubular member is open, and the first side of the external tubular member is fixed in a state of being tightly adhered to a periphery in a vicinity of the end on the first side of the shaft member.
